(19) United States
(12) Patent Application Publication
(10) Pub. No.: US 2020/0140352 A1
(43) Pub. Date: May 7, 2020

(54) SEEDING FORMULATION FOR WOODY PLANTS AND PRE-TREATMENT OF LAND SURFACES

(71) Applicant: VIRIDIS TERRA INNOVATIONS, Sainte-Marie (CA)

(72) Inventors: Martin BEAUDOIN NADEAU, Sainte-Marie (CA); Donald BLOUIN, Québec (CA); Frank GRENON, Québec (CA)

(73) Assignee: VIRIDIS TERRA INNOVATIONS, Sainte-Marie (CA)

(21) Appl. No.: 16/736,664

(22) Filed: Jan. 7, 2020

Related U.S. Application Data
(62) Division of application No. 15/878,090, filed on Jan. 23, 2018.
(60) Provisional application No. 62/449,169, filed on Jan. 23, 2017.

(51) Int. Cl. C05G 3/80; A01G 24/28; B09C 1/10; A01G 24/23; C05F 11/08; C05F 11/02; C09K 17/52; C09K 17/40; A01G 24/10; A01G 24/20; A01G 24/35

(52) U.S. Cl. CPC C05G 3/80; A01G 24/28; B09C 1/105; A01G 24/23; C05F 11/08; A01G 24/35; C09K 17/52; C09K 17/40; A01G 24/10; A01G 24/20; C05F 11/02

(57) ABSTRACT

The present disclosure provides a seeding formulation for woody plants and a pre-treatment of surfaces (e.g. rocks, waste rocks, tailings, overburden) on disturbed and degraded lands. The seeding formulation includes a mix of woody trees or shrubs seeds, organic mulch, beneficial microbial populations, mineral fertilizer, adhesive, absorbent polymer, and water. The pre-treatment of surfaces refers to the spreading or mixing of surfaces with organic biomass. Methods of preparing and applying the seeding formulation and pre-treatment are also disclosed. The formulation is used for the phytoremediation, ecological restoration, land reclamation, environmental rehabilitation, revitalization, revegetation, and reforestation of disturbed and degraded lands.

### CROSS-REFERENCE TO RELATED APPLICATIONS

This application is a divisional of U.S. application Ser. No. 15/878,090, filed Jan. 23, 2018, which claims the benefit of U.S. Provisional Application Ser. No. 62/449,169 filed Jan. 23, 2017, the disclosures of which are hereby incorporated in their entireties by reference herein.

### TECHNICAL FIELD

This disclosure relates to the field of seed establishment for the control of soil erosion, phytoremediation, ecological restoration, land reclamation, environmental rehabilitation, renaturalization, revitalization, revegetation, and reforestation of disturbed and degraded lands.

### BACKGROUND

Existing technologies to phytorestore, revegetate, and reforest disturbed and degraded lands mostly focus on seeding surfaces with herbaceous plants. Sometimes, tree and shrub seedlings are planted, following seeding with herbaceous plants or directly on surfaces without herbaceous plants. These technologies are not optimal.

Firstly, in forest ecosystems, seeding with herbaceous plants creates prairies with high cover density where tree and shrub natural colonization is difficult. Tree and shrubs are only able to colonize from surrounding ecosystems once herbaceous cover density is reduced to less than 60%. However, with lower cover density, soil erosion becomes a problem again. As a result, the development of the forest ecosystem is postponed and it may take hundreds of years to recover the forest ecosystem using this kind of technology. Past experiences have also shown that herbaceous cover degradation happens through time which often favours the establishment of invasive species, another unwanted issue.

Secondly, when tree and shrub seedlings are planted after seeding with herbaceous plants, two challenges are encountered: herbaceous plants favour the proliferation of rodents and strongly compete against woody plants. The rodents damage woody plants and have a negative impact on tree and shrub seedling survival and establishment. Competition by herbaceous plants also has a negative impact on tree and shrub seedling survival and establishment.

Thirdly, when only tree and shrub seedlings are planted, the erosion problem is not settled in the short term, but only in the long term. Furthermore, due to low cover density at the beginning, most biomass produced by the planted trees and shrubs (litterfall) do not stay on the ground and are transported far away by wind; thereby delaying soil revitalization and formation on the disturbed and degraded lands.

Fourthly, seeding with a mix of native herbaceous and woody plants does not perform well in the field, as mentioned in the article Clemente et al. (2016, Journal of Arid Environments, 125: 68-72). Under these circumstances, woody species are not able to establish and are rapidly outcompeted by herbaceous species, resulting in a plant cover made of almost 100% herbaceous plants (Oliveira et al. 2013, Ecological Engineering, 57: 18-26). Hence, current seeding practices lead to very very poor establishment of woody plants.

Due to all these problems and issues, there is a need for new technologies that allow sustainable revegetation, renaturalization, and rapid reforestation of disturbed and degraded lands while controlling erosion from wind and water in the short, mid, and long terms.

### SUMMARY

This disclosure provides an effective seeding formulation for woody plants, a pre-treatment of surfaces, and methods of preparing and applying the seeding formulation and pre-treatment.

This disclosure is used for the phytoremediation, ecological restoration, land reclamation, environmental rehabilitation, renaturalization, revitalization, revegetation, and reforestation of disturbed and degraded lands.

In a first aspect, the disclosure provides a seeding formulation which comprises from 0.00001 to about 5 weight percent of woody plant seeds (trees and shrubs), from about 1 to about 30 weight percent of organic mulch, from 0.01 to about 8 weight percent of mineral fertilizer, and between 50 weight percent and 98 weight percent of water.

Optionally, the formulation further comprises from 0.0001 to about 8 weight percent of beneficial microbial populations.

Optionally, the formulation further comprises from 0.001 to about 4 weight percent of adhesive.

Optionally, the formulation further comprises from 0.01 to about 6% of absorbent polymer.

This formulation is applied to lands or soil surfaces including rocks, waste rocks, tailings, overburden, and other disturbed soils.

The pre-treatment of surfaces for this disclosure consists of the prior application of organic biomass (such as ash, sludge, peat moss, manure, compost, wood, and grass) on rocks, waste rocks, and tailings. The same pre-treatment of surfaces may also be optionally used, on overburdened and other disturbed soils.

According to a further aspect, the present disclosure provides methods of preparing and applying the seed formulation comprising the steps of incorporating, mixing, and spreading the seeding formulation using a hydroseeder or directly spreading, manually or using machinery, the components of the formulation on the surfaces of disturbed and degraded lands.

According to a further aspect of the present disclosure, a first method of preparing and applying the seed formulation comprising of the steps of incorporating every component of the seeding formulation into a hydroseeder, mixing the seeding formulation inside the hydroseeder, and then spreading the seeding formulation using the hydroseeder on surfaces of the disturbed and/or degraded lands.

According to a further aspect, a second method of preparing and applying the seed formulation comprising of the step of spreading, manually or by using machinery, the components of the seeding formulation, separately or in mix, on surfaces of the disturbed and degraded lands.

According to a further aspect, the present disclosure also provides three methods of pre-treating of surfaces prior to application of the seed formulation.

According to a further aspect, a first method of pre-treatment comprises the steps of spreading, manually or by using machinery, exogenous organic biomass on surfaces of the disturbed and/or degraded lands and then optionally, mixing, manually or using machinery, the exogenous organic biomass with the surfaces.

According to a further aspect of the present disclosure, a second method of pre-treatment comprises the steps of producing the organic biomass on site by growing plants, processing the organic biomass to foster the desired soil physical properties (optimal soil structure with total porosity about 30% to 70%), and then optionally, mixing, manually or using machinery, the produced organic biomass with the surfaces.

According to a further aspect of the present disclosure, a third method of pre-treatment, which is required/appropriate when surface has been compacted by industrial activities, comprises the steps of making the surface rough and loose, manually or by using machinery, by digging holes on the surface and dumping the material generated from the holes in mounds between the holes.

### BRIEF DESCRIPTION OF THE DRAWINGS

FIGS. 1A and 1B show waste rocks from a gold mine treated without (FIG. 1A) or with (FIG. 1B) the process and formulation of the disclosure after three months of growth.

FIGS. 2A and 2B show fine tailings from a gold mine treated without (FIG. 2A) or with (FIG. 2B) the process and formulation of the disclosure after three months of growth.

FIG. 3 shows a waste rock pile immediately after being treated with the process and formulation of the disclosure.

FIG. 4 shows a fine tailing basin immediately after being treated with the process and formulation of the disclosure.

FIG. 5 shows trees and shrubs starting to grow on waste rock pile of FIG. 3, six weeks after being treated with the process and formulation of the disclosure.

FIG. 6 shows trees and shrubs starting to grow on fine tailing basin of FIG. 4, six weeks after being treated with the process and formulation of the disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

### Abbreviations

NPK: nitrogen/phosphorus/potassium; ECM: ectomycorrhizal fungi; AM: arbuscular mycorrhizal fungi; ERM: ericoid mycorrhizal fungi; PGPR: plant-growth promoting rhizobacteria.

### Definitions

As used herein the singular forms “a”, “an”, “and”, and “the” include plural referents unless the context clearly dictates otherwise. Thus, for example, reference to “a cell” includes a plurality of such cells and reference to “the culture” includes reference to one or more cultures and equivalents thereof known to those skilled in the art, and so forth. All technical and scientific terms used herein have the same meaning as commonly understood to one of ordinary skill in the art to which this disclosure belongs unless clearly indicated otherwise.

The term “about” as used herein refers to a margin of +or −10% of the number indicated. For sake of precision, the term about when used in conjunction with, for example: 90% means 90% +/−9% i.e. from 81% to 99%. More precisely, the term about refer to +or −5% of the number indicated, where for example: 90% means 90% +/−4.5% i.e. from 86.5% to 94.5%. When used in the context of a pH, the term “about” means +/−0.5 pH unit.

The term “up to” as used herein refers to a margin of greater than 0 but no more than the number indicated.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

The term “tree” as used herein refers to a woody perennial plant, typically having a single stem of trunk growing to a considerable height and bearing lateral branches at some distance from the ground.

The term “shrub” as used herein refers to a woody plant that is smaller than a tree and has several main stems arising at or near the ground.

The term “spring” as used herein refers to the period of the year (season) from March 21^{st} to June 20^{th} in the northern hemisphere.

The term “summer” as used herein refers to the period of the year (season) from June 21^{st} to September 20^{th} in the northern hemisphere.

The term “fall” as used herein refers to the period of the year (season) from September 21^{st} to December 20^{th} in the northern hemisphere.

This disclosure provides an effective seeding formulation for woody plants, and methods of preparing and applying the seeding formulation and pre-treatment on surfaces of disturbed and/or degraded lands. This disclosure is applied to surfaces including rocks, waste rocks, tailings, overburden, and other disturbed and/or degraded soils.

This disclosure is used for the phytoremediation, ecological restoration, land reclamation, environmental rehabilitation, renaturalization, revitalization, revegetation, and reforestation of disturbed and/or degraded lands. These disturbed and/or degraded lands include, but are not limited to: mined sites, oil sands sites, industrial sites, contaminated sites, brownfields, eroded lands, degraded agricultural fields, degraded forest ecosystems, lands affected by desertification, denuded lands, and all other types of disturbed and degraded soils and ecosystems.

### Seeding Formulation

In a first aspect, the disclosure provides a seeding formulation which comprises from 0.00001 to about 5 weight percent of woody plant seeds (trees and shrubs), from about 1 to about 30 weight percent of organic mulch, from 0.01 to about 8 weight percent of mineral fertilizer, between about 50 weight percent and about 98 weight percent of water.

Particularly, the seeding formulation comprises from 0.00001 to about 2% of woody plant seeds, or more particularly from 0.00002% to about 1% of woody plants seeds.

Particularly, the seeding formulation comprises from 1% to 25% of organic mulch, more particularly from about 1% to about 23%, most particularly from about 1% to about 20%.

Particularly, the seeding formulation comprises from 0.01% to about 6% of mineral fertilizer, more particularly from 0.01% to about 4%.

Particularly, the seeding formulation comprises from 60% to 98% of water more particularly from about 70% to about 98% of water.

According to a particular embodiment of this disclosure, there is provided a seeding formulation comprising/consisting essentially of/consisting of: from 0.00002 to about 1% of woody plant seeds; from about 1 to about 23% of organic mulch; from 0.01 to about 4% of mineral fertilizer; and from about 50 to about 98% of water.

Optionally, the formulation further comprises from 0.00001 to about 8 weight percent of beneficial microbial populations, more particularly from 0.0001 to about 5% of beneficial microbial populations; and most particularly from 0.0001 to about 3 weight percent of beneficial microbial populations.

Optionally, the seeding formulation further comprises from 0.001 to about 4 weight percent of adhesive; particularly from 0.003 to about 2% of adhesive.

In accordance with a further aspect of this disclosure, there is provided a seeding formulation comprises/consists essentially of/consists of: from 0.00001 to about 5 weight percent of woody plant seeds (trees and shrubs), about 1 to about 30 weight percent of organic mulch, from 0.0001 to about 8% (w) of beneficial microbial population; 0.01 to about 8 weight percent of mineral fertilizer, 0.001 to about 4 weight percent of adhesive and between about 50 weight percent and about 98 weight percent of water.

According to a particular embodiment of this disclosure, there is provided a seeding formulation comprising/consisting essentially of/consisting of: from 0.00002 to about 1% of woody plant seeds; from about 1 to about 23% of organic mulch; from 0.0001 to about 5% (w) of beneficial microbial population; from 0.01 to about 4% of mineral fertilizer; 0.003 to about 2 weight percent of adhesive; and from about 60 to about 98% of water.

Optionally, the seeding formulation further comprises an absorbent polymer to retain humidity of the formulation when used in dry conditions or seasons. Particularly, for dry seasons such as spring and summer seeding, the formulation may further comprise from 0.01 to about 6% of absorbent polymer, while this is optional for fall seeding. Particularly, when used, the seeding formulation may further comprise from 0.02 to about 2% of absorbent polymer.

According to a particular embodiment, the seeding formulation for this disclosure comprises/consists essentially of/consists of: 0.00001 to about 5% by weight of woody plant seeds (trees and shrubs), about 1 to about 30% by weight of organic mulch, 0.0001 to about 8% by weight of beneficial microbial populations, 0.01 to about 8% by weight of mineral fertilizer, 0.001 to about 4% by weight of adhesive, 0.01 to about 6% by weight of absorbent polymer, and between about 50 and about 98% by weight of water.

According to a particular embodiment of this disclosure, there is provided a seeding formulation comprising/consisting essentially of/consisting of: from 0.00002 to about 1% of woody plant seeds; from about 1 to about 23% of organic mulch; from 0.0001 to about 5% (w) of beneficial microbial population; from 0.01 to about 4% of mineral fertilizer; 0.003 to about 2 weight percent of adhesive; 0.02 to about 2% by weight of absorbent polymer and from about 60 to about 98% of water.

In accordance with an embodiment of the disclosure, the woody plant seeds include one, several, or many species of trees and shrubs. Each species represents from 0.01% to 100% of total seed count. Particularly, the species of trees suitable for the present disclosure are selected from the group of genus: Populus, Betula, Alnus, Salix, Picea, Pinus, Abies, Larix, Thuja, Tsuga, Pseudotsuga, Acer, or Fraxinus. Particularly, the species of shrubs suitable for the present disclosure are selected from the group of genus: Salix, Alnus, Betula, Vaccinium, Sambucus, Viburnum, Cornus, Sorbus, Prunus, Rhododendron, or Arctostaphylos.

In accordance with an embodiment of the disclosure, the plant seeds formulation includes 1 or up to 2, 3, 4, 5, 6, 7, 8, 9 or 10 species included from: Populus tremuloides, Populus balsamifera, Betula papyrifera, Salix discolor, Alnus crispa, Alnus rugosa, Pinus banksiana, Picea glauca, Picea mariana, or Larix laricina.

In accordance with an embodiment of the disclosure, the woody plant seeds formulation includes 1, or up to 2, 3, 4, 5, 6, 7, 8 or 9 species included from: Populus tremuloides, Populus balsamifera, Betula papyrifera, Salix discolor, Betula alleghaniensis, Pinus banksiana, Picea glauca, Picea mariana, or Larix laricina.

According to another embodiment of the disclosure, the organic mulch comprises one or a mix of the following organic materials: fertilizing residual materials (ash, biochar, sewage sludge, paper mill sludge, and biosolids), peat moss, manure, grass, hay, straw, leaf, compost, wood (bark, sawdust, wood chips, and wood fibers), or cellulose fiber.

The beneficial microbial populations according to an embodiment of the disclosure consist of one or a mix of the following microorganisms: saprophytic fungi (white rot fungi, and brown rot fungi), mycorrhizal fungi (ectomycorrhizal (ECM) fungi, arbuscular mycorrhizal (AM) fungi, and ericoid mycorrhizal (ECM) fungi), plant-growth promoting rhizobacteria (PGPR) (soil bacteria), nitrogen-fixing bacteria (free-living bacteria and mutualistic bacteria), nitrogen-fixing actinomycetes (Frankia), or endophytes (endophytic fungi and endophytic bacteria).

According to a particular embodiment, the white rot fungi is from the genus: Pleurotus, Phanerochaete, Trametes or Lentinula.

According to a particular embodiment, the brown rot fungi is from the genus: Phaeolus, Fomitopsis, Serpula or Fibroporia.

According to an alternative embodiment, the ECM fungi is from the genus: Laccaria, Hebeloma, Tricholoma, Suillus, Amphinema, Alpova, Paxillus or Pisolithus.

In accordance with a further particular embodiment, the AM fungi is from the genus: Rhizophagus or Glomus.

According to a particular embodiment, the ERM fungi is from the genus: Rhizoscyphus, Oidiodendron, Meliniomyces or Hymenoscyphus.

According to an alternative embodiment, the PGPR is from the genus: Bacillus, Pseudomonas, Bulkholderia, Paenibacillus or Arthrobacter.

According to a particular embodiment, the Nitrogen-fixing bacteria is from the genus: Azotobacter, Rhizobium, Agrobacterium, Acetobacter or Enterobacter.

In accordance with a particular embodiment, the endophytic fungi is from the genus: Cadophora, Phialocephala or Cenococcum.

According to a further embodiment, the endophytic bacteria is from the genus: Bacillus, Pseudomonas, Bulkholderia, Paenibacillus or Arthrobacter.

According to another embodiment of the disclosure, the mineral fertilizer particularly comprises one or a combination of fast and slow release liquid, powder, and granular NPK fertilizers; for example, fast release liquid NPK 10-52-10 with 25 to 100 PPM nitrogen, semi-slow release granular NPK 8-31-8 with 150 to 500 kg/ha, and/or slow release granular NPK 14-14-14 with 100 to 300 kg/ha.

In accordance with another embodiment of the disclosure, the adhesive particularly comprises one or a combination of powdered and granular glue (any tackifiers made from a polymer based mixture used to increase the stickiness of the hydroseed mulch to be mixed), and vegetative gum (any tackifiers made from plant carbohydrate molecules used to increase the stickiness of the hydroseed mulch to be mixed).

According to a particular embodiment of the disclosure, the absorbent polymer comprises of one or more hydrogels made of: sodium polyacrylate, polyvinyl alcohol, acrylate, carboxymethylcellulose, or methylcellulose, or combinations thereof.

### Application Concentrations

Particularly, the seeding formulation is applied on the disturbed and degraded lands at a concentration of about: from 0.025 kg/ha to 10 kg/ha of woody plant seeds, from 1 500 kg/ha to 6 000 kg/ha of organic mulch, from 100 L/ha to 500 L/ha of liquid microbial inoculant with more than 103 propagules/ml or from 0.10 kg/ha to 0.25 kg/ha on seeds of powder microbial inoculant with more than 103 propagules/g of beneficial microbial populations, from 10 L/ha to 200 L/ha of fast release liquid fertilizer, from 200 kg/ha to 600 kg/ha of slow release granular fertilizer, from 3 kg/ha to 400 kg/ha of adhesive, and from 20 000 L/ha to 80 000 L/ha of water.

Preferably in dry conditions such as in spring and summer, while optionally in fall seeding activities, the seeding formulation also comprises from 20 kg/ha to 300 kg/ha of an absorbent polymer.

### Method of Preparation of Formulation

In accordance with another embodiment, the present disclosure comprises two methods of preparing and applying the seed formulation. Particularly, the first method of preparing and applying the seed formulation consists of incorporating every component of the seeding formulation as defined above into a hydroseeder, mixing the seeding formulation inside the hydroseeder, and then spreading the seeding formulation using the hydroseeder on surfaces of the disturbed and degraded land.

Particularly, the second method of preparing and applying the seed formulation consists of spreading, manually or by using machinery, the components of the seeding formulation, separately or in mix, on surfaces of the disturbed and degraded land. Surfaces include rocks, waste rocks, tailings, overburden, and other disturbed soils.

### Method of Pre-Treatment of Surfaces

According to another embodiment of the disclosure, the pre-treatment of surfaces, prior to the application of the seeding formulation, comprises the step of spreading a layer of organic biomass on rocks, waste rocks, and tailings. The same pre-treatment of surfaces may be carried out on overburden and other disturbed soils. The organic biomass spread during the pre-treatment may comprise one or a mix of the following materials: fertilizing residual materials (ash, biochar, sewage sludge, paper mill sludge, and biosolids), peat moss, manure, grass, hay, straw, leaf, compost, and wood (bark, sawdust, wood chips, and wood fibers).

In accordance with another embodiment, the present disclosure includes two methods of preparing and applying the pre-treatment of surfaces. Particularly, the first method comprises the steps of: spreading, manually or by using machinery, exogenous organic biomass on surfaces of the disturbed and degraded lands and then optionally, mixing, manually or using machinery, the exogenous organic biomass with the surfaces. Particularly, the second method comprises the steps of: producing the organic biomass on site by growing plants, processing the organic biomass to foster the desired soil physical properties, and then mixing, manually or using machinery, the produced organic biomass with the surfaces. Producing the organic biomass on site in the second method consists of producing one or a mix of grass, hay, straw, leaf, and wood on site. The wood is processed into bark chips, wood chips, sawdust, or wood fibers before mixing with the surfaces and applying the seeding formulation.

In accordance with another embodiment, the present disclosure includes an additional pre-treatment of surfaces, prior to spreading a layer of organic biomass when surface has been compacted by industrial activities, which comprises the steps of making the surface rough and loose, manually or by using machinery, by: digging holes on the surface and then dumping the material generated from the holes in mounds between the holes. Particularly, spaces between holes where the material is dumped are half the size of the holes. Hence, half material of the bucket load falls on top of the space between holes and the other half falls back into holes; thus, creating mounds and a nice rough and loose terrain.

Particularly, the desired soil physical properties to be achieved for the pre-treatment of the surface to be considered successful refer to an optimal soil structure with total porosity about 30% to 70%.

The following examples are put forth so as to provide those of ordinary skill in the art with a complete disclosure and description of how to make and use the present disclosure, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1—Greenhouse Trial

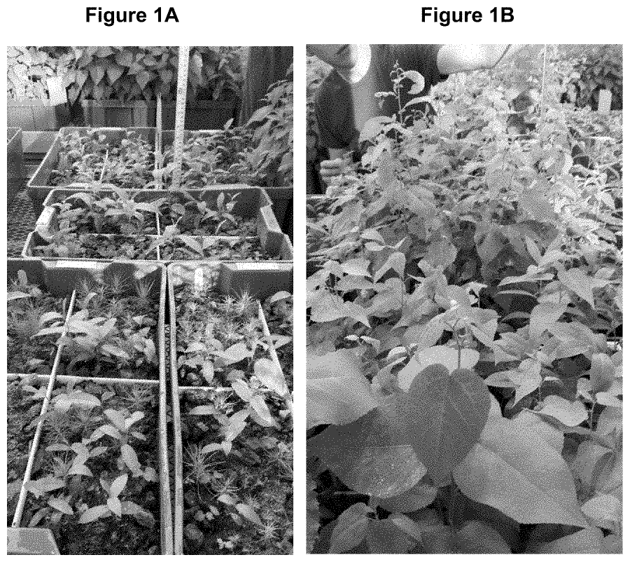

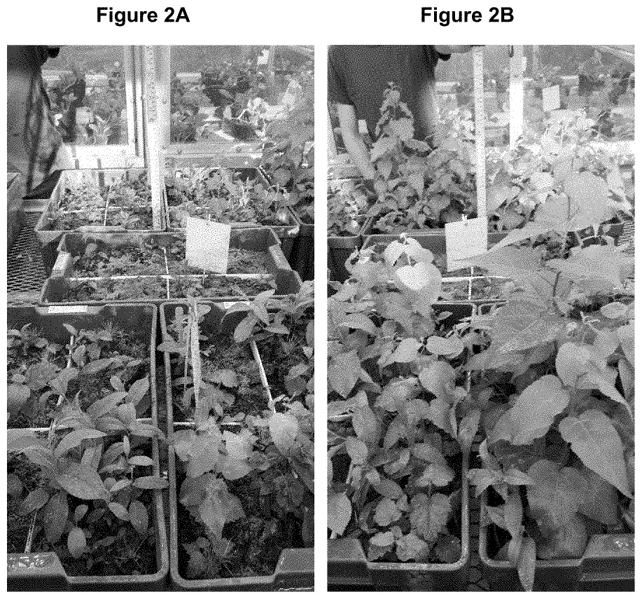

The process and formulation of the disclosure was applied to soil surfaces of overburden, waste rocks, and tailings from a gold mine of the Quebec Abitibi region under controlled conditions in a glasshouse (see FIGS. 1 and 2).

Six different variables were tested in the trial: straw as a pretreatment of surface (4 000 kg/ha or without), wood fibers as an organic mulch (3 000 kg/ha, 1 500 kg/ha, or without), Pleurotus ostreatus inoculant as beneficial microbial population (with or without), semi-slow release granular NPK 8-31-8 fertilizer as a mineral fertilizer (386 kg/ha or without), proportion of hardwood seeds (60%, 70%, 80%, or 90%), and seed coating (Alginate+Peat+NPK, Alginate+Biochar+NPK, Alginate+Peat, Alginate+Biochar, Alginate+NPK, Alginate, or without). The seeding formulation also included water, vegetative gum as an adhesive and liquid NPK 10-52-10 fertilizer.

Ten species of trees and shrubs were tested: Populus tremuloides, Populus balsamifera, Betula papyrifera, Salix discolor, Alnus crispa, Alnus rugosa, Pinus banksiana, Picea glauca, Picea mariana, and Larix laricina. The trial lasted five months.

### Results

Seed coating had no significant positive effect on seed germination, woody plant productivity, and survival. Straw increased woody plant productivity by up to 14-fold and seed germination and survival by up to 4-fold. Wood fibers enhanced woody plant productivity by up to 3-fold and seed germination and survival by up to 2-fold. The inoculant improved woody plant productivity by up to 37% and seed germination and survival by up to 42%. Granular fertilizer application has an impact on seedling growth and survival on waste rocks and tailings, but not on overburden. Proportion of hardwood seeds had mixed effects on seed germination, woody plant productivity, and survival depending on soil surfaces and woody plant species. Cold moist stratification had no effect on neither seed germination rate nor speed.

### Example 2—Field Trial

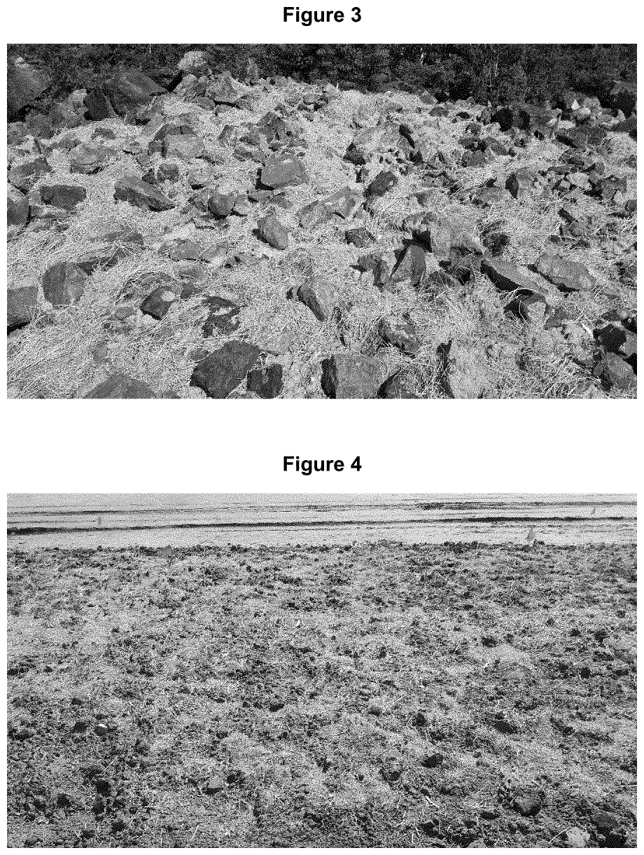

The process and formulation of the disclosure was later applied in the field to soil surfaces of overburden, waste rocks, and tailings in an abandoned gold and copper mine of the Northern Quebec, Chibougamau region (see FIGS. 3 and 4).

The process and formulation as determined in the previous greenhouse trial was tested with four new variables: humidity retainer (absorbent polymer made of sodium polyacrylate (150 kg/ha), additional mulch made of ramial wood chip (100 m³/ha), or nothing), additional nutritional stimulant (slow release granular NPK 14-14-14 fertilizer (200 kg/ha), mycorrhizal inoculant made of a specific Hebeloma crustuliniforme strain, or nothing), ground stabilizer (adhesive made of vegetative gum (6 kg/ha) or nothing), plant density (based on greenhouse results, density of 160,000, 320,000, and 640,000 established seedlings per hectare).

The seeding formulation included nine Woody species: Populus tremuloides, Populus balsamifera, Betula papyrifera, Salix discolor, Betula alleghaniensis, Pinus banksiana, Picea glauca, Picea mariana, and Larix laricina.

### Results

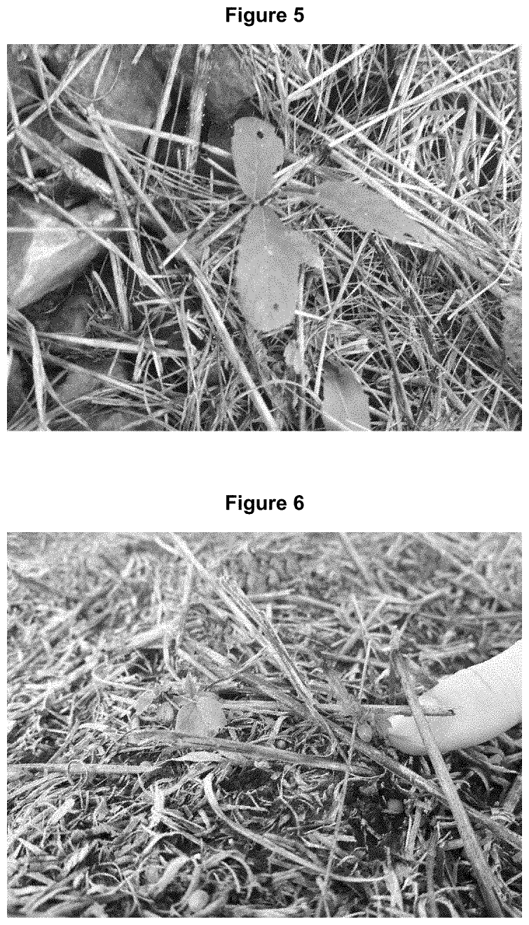

The most effective process and formulation from the previous greenhouse trial was successful in promoting and establishing a woody cover on mine waste in the field as shown in FIGS. 5 and 6. The absorbent polymer improved by more than 2-fold the ability of wood fiber to retain humidity which generally had a positive effect on seed germination. The vegetative gum was effective to maintain (i.e. more than 90% of) the formulation in place on these windy degraded surfaces prior seed germination, because Pleurotus ostreatus inoculant was less effective in the short term for accomplishing this task.

Seeds without cold moist stratification from species that normally release their mature seeds in the environment in the fall (Betula papyrifera, Betula alleghaniensis, Picea glauca, Picea mariana, Pinus banksiana, Larix laricina) took up to more than three months to germinate in the field compared to about 6 weeks when stratified, which is very different than the previous greenhouse results. As a result, cold moist stratification of seeds of these species with fall-releasing seeds is preferable for more rapid seedling establishment.

The present disclosure has been described in terms of particular embodiments found or proposed by the present inventor to comprise preferred modes for the practice of the disclosure. It will be appreciated by those of skill in the art that, in light of the present disclosure, numerous modifications and changes can be made in the particular embodiments exemplified without departing from the intended scope of the disclosure. All such modifications are intended to be included within the scope of the appended claims.

All publications and patent applications cited in this specification are herein incorporated by reference as if each individual publication or patent application were specifically and individually indicated to be incorporated by reference.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A seeding formulation comprising:
from 0.00001 to about 5 weight percent of woody plant seeds, wherein the woody plant seeds comprise at least one species of trees or shrubs, or combinations thereof;
from 1 to about 30 weight percent of organic mulch;
from 0.01 to about 8 weight percent of mineral fertilizer;
from 50 weight percent to about 98 weight percent of water.

2. The seeding formulation of claim 1, further comprising from 0.0001 to about 8 weight percent of beneficial microbial populations.

3. The seeding formulation of claim 1, further comprising from 0.001 to about 4 weight percent of adhesive.

4. The seeding formulation of claim 1, further comprising from 0.01 to about 6% of absorbent polymer.

5. The seeding formulation of claim 1, wherein the tree species is from a genus selected from the group consisting of: Populus, Betula, Alnus, Salix, Picea, Pinus, Abies, Larix, Thuja, Tsuga, Pseudotsuga, Acer, and Fraxinus.

6. The seeding formulation of claim 5, wherein the shrub species is from a genus selected from the group consisting of: Salix, Alnus, Betula, Vaccinium, Sambucus, Viburnum, Cornus, Sorbus, Prunus, Rhododendron, and Arctostaphylos.

7. The seeding formulation of claim 5, wherein each of the genus of trees or shrubs consist of 0.01% to 100% of total seed count.

8. The seeding formulation of claim 1, wherein the organic mulch comprises one or a mix of the following materials: fertilizing residual materials, peat moss, manure, grass, hay, straw, leaf, compost, wood, and cellulose fiber.

9. The seeding formulation of claim 8, wherein the fertilizing residual materials comprise one or more of ash, biochar, sewage sludge, paper mill sludge, and biosolids.

10. The seeding formulation of claim 1, wherein the beneficial microbial populations comprise one or a mix of microorganism selected from the group consisting of:
saprophytic fungi, mycorrhizal fungi, plant-growth promoting rhizobacteria (PGPR), nitrogen fixing bacteria, nitrogen fixing actinomycetes, and endophytes.

11. The seeding formulation of claim 10, wherein the saprophytic fungi comprise one or more of white rot fungi and brown rot fungi.

12. The seeding formulation of claim 10, wherein the mycorrhizal fungi comprise one or more of: ectomycorrhizal (ECM) fungi, arbuscular mycorrhizal (AM) fungi, and ericoid mycorrhizal (ERM) fungi.

13. The seeding formulation of claim 10, wherein the plant-growth promoting rhizobacteria (PGPR) comprise one or more species of soil bacteria.

14. The seeding formulation of claim 10, wherein the nitrogen fixing actinomycetes comprise one or more species of genus Frankia.

15. The seeding formulation of claim 1, wherein the mineral fertilizer comprises one or a combination of liquid, powder, and granular NPK fertilizers.

16. The seeding formulation according to claim 1, wherein the adhesive comprises one or a mix of the following materials: powdered and granular glue, and vegetative gum selected from the group consisting of tackifiers made from a polymer based mixture and/or plant carbohydrate molecules.

17. The seeding formulation according to claim 4, wherein the absorbent polymer comprises one or more hydrogels made of: sodium polyacrylate, polyvinyl alcohol, acrylate, carboxymethylcellulose, or methylcellulose, or a mixture thereof.

18. A method for preparing and applying the seeding formulation as defined in claim 1, comprising the following steps:
incorporating all components of the seeding formulation of claim 1 into a hydroseeder;
mixing the seeding formulation inside the hydroseeder; and
spreading the seeding formulation using the hydroseeder on a surface of a disturbed and degraded land.

19. The seeding formulation of claim 1, consisting of: from 0.00002 to about 1% of woody plant seeds; from about 1 to about 23% of organic mulch; from 0.0001 to about 5% (w) of beneficial microbial population; from 0.01 to about 4% of mineral fertilizer; 0.003 to about 2 weight percent of adhesive; 0.02 to about 2% by weight of absorbent polymer and from about 60 to about 98% of water.
